(19) United States
(12) Patent Application Publication
(10) Pub. No.: US 2007/0074416 A1
(43) Pub. Date: Apr. 5, 2007

(54) Absolute position measurement system and method of producing material measure for the same

(76) Inventor: Guenter Reusing, Niederwerrn (DE)

Correspondence Address: STRIKER, STRIKER & STENBY, 103 EAST NECK ROAD, HUNTINGTON, NY, 11743, US

(21) Appl. No.: 11/516,936

(22) Filed: Sep. 7, 2006

(30) Foreign Application Priority Data
Sep. 30, 2005 (DE) 10 2005 047 009.2

(51) Int. Cl. G01D 5/347

(52) U.S. Cl. 33/706

(57) ABSTRACT

A position measurement system has a material measure provided with incremental and absolute markings, and a scanner movable relative to the markings, wherein the incremental markings are formed by periodically located recesses on the material measure, and the absolute marking are located between the recesses of the material measure.

### CROSS-REFERENCE TO A RELATED APPLICATION

The invention described and claimed hereinbelow is also described in German Patent Application DE 10 2005 047 009.2 filed on Sep. 30, 2005. This German Patent Application, whose subject matter is incorporated here by reference, provides the basis for a claim of priority of invention under 35 U.S.C. 119(a)-(d).

### BACKGROUND OF THE INVENTION

The invention relates to an absolute position measurement system

Such position measurement systems are known, for instance from European Patent Disclosure EP 1 052 480 B1. This reference shows a position measurement system that is integrated into a linear roller bearing, the latter comprising a guide rail and a trolley. The material measure is formed by a steel measuring tape, which is held taut in the longitudinal direction of the guide rail. On the measuring tape, periodically located rectangular cutouts are provided, which form the incremental markings. Reference markings are also provided, which identify predetermined absolute positions on the guide rail. In a first embodiment, the absolute markings are embodied as cutouts on the measuring tape. In a second embodiment, these markings are embodied as bores in the guide rail. In both cases, the reference markings are located next to the incremental markings. A scanner is mounted on the trolley and scans both the incremental and the absolute markings and from them forms an absolute position value. This is accordingly called a quasi-absolute position measurement system.

From U.S. Pat. No. 6,064,851 B1, a further measurement system is known, which has incremental and absolute markings that are likewise located side by side. Both sets of markings are embodied such that they can be scanned inductively, for instance being in the form of openings or indentations on the material measure. In this embodiment, each incremental marking is assigned an absolute marking that carries binary information. A plurality of adjacent markings together yield an unambiguous position code, which assigns one absolute position along the material measure to each incremental marking. As a result, as soon it is turned on, the position measurement system knows its own absolute position, without requiring that it move to the next reference marking. Using both absolute and incremental markings makes it possible to attain greater measurement accuracy than can be attained with a measurement system that functions exclusively in absolute fashion, since by interpolation of the incremental measurement signals, a higher measurement resolution can be achieved than would correspond to the spacing of the incremental markings.

The disadvantage of the position measurement systems described resides in the great width of the material measure. This is especially disadvantageous whenever the incremental and absolute markings are to be located between the raceways of a linear roller bearing, since the space there is limited.

### SUMMARY OF THE INVENTION

It is therefore the object of the invention to create a position measurement system whose material measure has a reduced width.

In keeping with these objects and with others which will become apparent hereinafter, one feature of the present invention resides, briefly stated, in a position measurement system, comprising a material measure provided with incremental and absolute markings, and a scanner movable relative to said markings, wherein said incremental markings are formed by periodically located recesses on said material measure, and said absolute marking are located between said recesses of said material measure.

The invention is based on the recognition that the space between the incremental markings typically forms a substantially flat surface, which has a constant spacing from the scanner and can thus be scanned well. Moreover, between the incremental markings, essentially the same area as the incremental markings themselves occupy is available. This is especially true if the recesses are scanned inductively, since only then are approximately sinusoidal scanning signals created, which can be well interpolated. Moreover, the arrangement according to the invention assures that the absolute markings are unambiguously associated with a predetermined incremental marking. The possibility that the incremental and absolute markings are displaced so unfavorably relative to one another in the measurement direction that the association is no longer unambiguous is precluded.

In a preferred embodiment, the recesses are identical to one another and are located in a row. The recesses may for instance be openings in a measuring tape that are produced by means of etching. However, the recesses may also be indentations in a solid material measure that are likewise produced by etching or by metal-cutting machining. The known rectangular incremental markings are preferred, since between them, a compact and in particular rectangular surface is available that is well suited to the application of the absolute markings.

The position measurement system of the invention is especially advantageous if one absolute marking is located between each incremental marking. In this case, the absolute markings require an especially large amount of space. The space-saving effect by the arrangement according to the invention is therefore especially pronounced.

The absolute markings may carry binary information, and the information of a plurality of adjacent absolute markings together yields unambiguous, absolute position information. Binary absolute markings are especially easy to produce, and in particular are simpler to produce than markings that have a higher information content. They can therefore be introduced correspondingly simply into the limited space between the incremental markings.

The incremental markings can furthermore be scanned inductively and the absolute markings noninductively by the scanner. For the measurement precision in scanning the incremental markings, it is decisive that the absolute markings do not interfere with the incremental signal. The incremental markings present, in the form of recesses, are especially well suited for inductive scanning. The absolute markings must therefore be embodied such that they do not affect the flow of current in the electrically conductive material measure. Markings that are noninductively scannable are particularly well suited for this.

In the case of magnetic absolute markings, the regions between the recesses of the material measure can be magnetized with different polarization. The polarization thus carries binary information, which can be read out with the aid of magnetoresistive sensors, Hall sensors, or the like. The inductive scanning of the incremental markings is affected neither by the incorporation of the magnetic markings nor by the readout of the them.

The situation is similar for optical markings. In this case, the surface of the material measure between the incremental markings can be equipped with different reflective properties in terms of optical radiation. For instance, this can be done by locally blackening the metal and hence reflective material measure, using laser beams. Such optical markings in turn carry binary information, which can be scanned with the aid of optical beams. In this case as well, the inductive scanning of the incremental markings is affected neither by the presence of the optical markings nor by their scanning.

From the above, it will be apparent that the scanner may have two separate sensors for scanning the incremental and absolute markings, since these are meant to operate on different physical principles. These sensors are preferably located one after the other in the measurement direction, so that they do not affect one another in their work. Because of the periodic structure of the incremental markings, the spacing of the two sensors is essentially of no significance. Only the phase relationship of the preferably sinusoidal incremental signals relative to the absolute signals has to be taken into account in calculating the absolute position measurement value. It should be noted at this point that the absolute and incremental sensors may be located at the same place in the measurement direction, if that is necessary for reasons of space. For instance, it may be contemplated that the sensors be located one above the other or side by side.

It is advantageous if the absolute markings are located exactly in the middle between the incremental markings. In this way, the absolute markings can be made especially wide, and as a result when they are scanned an especially strong signal is created. This object can be attained in a material measure of the invention by providing that the incremental markings are scanned during the production of the absolute markings, or that the absolute markings are scanned during the production of the incremental markings.

This method can be performed especially simply if the invention is employed in conjunction with the linear roller bearing described at the outset. In that case, a guide rail with incremental markings is produced first. Next, a device for applying the absolute markings to the material measure, namely the guide rail, is connected to the trolley, on which the scanner for scanning the incremental markings is already mounted. The device is thus guided linearly movably in relation to the material measure, when the trolley runs on the guide rail. The spacing between the material measure and the device experiences only the slightest fluctuations during the motion of the trolley. The device is now moved along the guide rail, and the guide rail is controlled, by evaluating the scanning signals, in such a way that the absolute markings are put in the desired relation to the incremental markings.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a linear roller bearing, which has a position measurement system according to the invention; and

FIG. 2 shows a material measure of the position measurement system of FIG. 1 according to invention.

### DESCRIPTION OF THE PREFERRED EMBODIMENTS

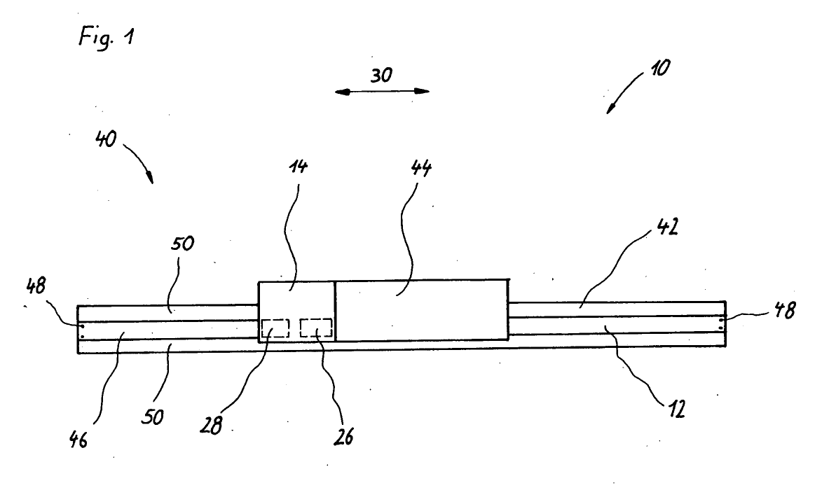

In FIG. 1, a position measurement system 10 of the invention is shown quite schematically. It is integrated into a linear roller bearing 40, which comprises a steel guide rail 42 and a trolley 44. The material measure 12 in the form of a measuring tape 46 of sheet steel approximately 0.3 mm thick is held taut in the longitudinal direction 30 of the guide rail 42. On the ends of the measuring tape 46, spot welds 48 are provided, with which the measuring tape 46 is secured in the taut state to the guide rail.

Trolleys 44 for the roller bodies, not shown, are mounted above and below the measuring tape 46, and the roller bodies revolve endlessly in the trolley 44, so that the trolley is braced longitudinally movably on the guide rail. The spacing of the raceways 50 determines the maximum width of the material measure 12.

A scanner 14 is mounted on the trolley 44, and a plurality of sensors 26; 28 for scanning the measuring tape 46 are provided in it. The scanner is guided by the trolley 44 in relation to the measuring tape in such a way that the spacing between the sensors 26; 28 and the measuring tape is essentially constant.

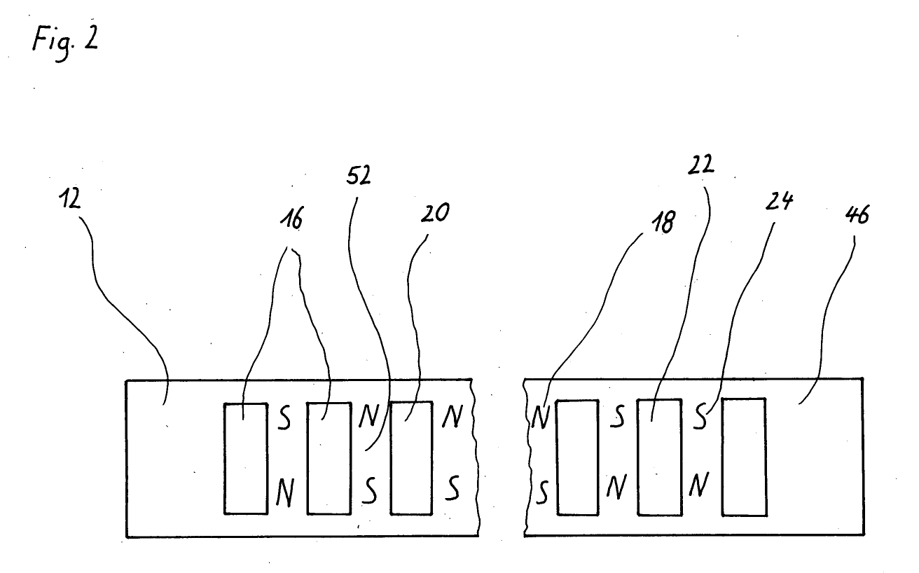

In FIG. 2, the measuring tape 46 is shown enlarged. It includes incremental markings 16 in the form of recesses 20, which are embodied as rectangular openings 22. The openings 22 are all identical to one another and have a width of 0.5 mm. The spacing of the openings is likewise 0.5 mm. The openings 22 are produced very precisely, with a slight, predetermined undersize, by means of etching, so that in the taut state of the measuring tape 46, a division period of exactly 1.0 mm results. The incremental sensor 26 for scanning the incremental markings 16 is embodied in accordance with EP 1 164 358 B1, which is hereby expressly incorporated in full by reference. This incremental sensor, in conjunction with the present material measure 12, generates virtually exact periodical, sinusoidal signals, which can be divided by the factor 1000 by means of an interpolation evaluation process, so that the present position measurement system 10 attains a resolution of 0.001 mm.

Magnetic markings 24, which form the absolute markings 18, are placed between the rectangular openings 22. The measuring tape 46 is produced for that purpose of a hard magnetic steel, such as a martensitic steel, so that the magnetization will be permanent. The individual magnetic markings 24 are polarized in alternation transversely to the measurement direction 30, so that they carry binary information. A north pole (N) of a magnetic marking 24 at the upper edge of the measuring tape 46 is assigned the information logical 1, and a south pole on the upper edge of the measuring tape 46 is correspondingly assigned the information logical 0. The absolute markings which are shown as examples in FIG. 2 accordingly carry the following information:

011 . . . 100

The bottom edges of the measuring tape 46 always have the opposite polarization from the upper edge. The magnetic markings 24 are produced by the method described above, in which the device for applying the magnetic markings is an electromagnet. The polarization of the electromagnet is controlled on the basis of the signals of the incremental sensor 26 in such a way that the lands 52 of the measuring tape 46 are unambiguously magnetized. It should be noted at this point that the magnet polarization may also be oriented in any other direction in space, as long as the different polarizations can be distinguished from one another by an appropriate sensor.

The absolute markings form a pseudorandom sequence of numbers and are evaluated in accordance with U.S. Pat. No. 4,009,377, which is hereby expressly incorporated in full by reference. The sequence of numbers is accordingly selected such that a plurality of adjacent absolute markings together yield unambiguous, absolute position information. The absolute sensor 28 comprises a plurality of magnetoresistive elements, which are located one after the other in the measurement direction 30 at a spacing of 1.0 mm, corresponding to the incremental division. The number of magnetoresistive elements is dependent on the length of the measuring tape and will be selected such that all the absolute markings that are required for unambiguous identification of an absolute position can be read off simultaneously.

In FIG. 1, the incremental sensor 26 and the absolute sensor 28 are located one after the other in the measurement direction 30. The magnetoresistive elements of the absolute sensor 28 are always interrogated whenever they are located precisely above the absolute markings 18, or in other words above the lands 52 of the measuring tape 46. This is always the case whenever the sine-cosine signals of the incremental sensor 26 have a defined phase relationship, which is ascertained the first time the position measurement system is put into operation.

In an improved embodiment, a plurality of groups of the above-described magnetoresistive elements may be provided, which are offset from one another by an integral fraction of the measurement division. Thus regardless of the position of the scanner 14, one group is always located above the lands 52 of the measuring tape 46. It is thus assured that after the position measurement system 10 is switched on, an absolute position can be ascertained immediately, without having to move the scanner 14.

It will be understood that each of the elements described above, or two or more together, may also find a useful application in other types of constructions and methods differing from the types described above.

While the invention has been illustrated and described as embodied in a absolute position measurement system, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A position measurement system, comprising a material measure provided with incremental and absolute markings; a scanner movable relative to said markings, said incremental markings being formed by periodically located recesses on said material measure, said absolute marking being located between said recesses of said material measure.

2. A position measurement system as defined in claim 1, wherein said recesses are identical to one another and located in a row.

3. A position measurement system as defined in claim 2, wherein said recesses that are identical to one another are configured as rectangular recesses.

4. A position measurement system as defined in claim 1, wherein said markings and recesses are arranged so that one of said absolute markings is located between each recess.

5. A position measurement system as defined in claim 1, wherein said absolute marking carries binary information configured so that the information of a plurality of adjacent ones of said absolute markings together yield unambiguous absolute position information.

6. A position measurement system as defined in claim 1, wherein said incremental markings and said absolute markings are configured so that said incremental markings are scanned inductively and said absolute markings are scanned noninductively by the scanner.

7. A position measurement system as defined in claim 6, wherein said absolute markings and said scanner are configured so that said absolute markings are scanned noninductively in a fashion selected from the group consisting of magnetically and optically.

8. A position measurement system as defined in claim 6, wherein said scanner has two separate sensors which are configured for scanning said incremental markings and said absolute markings and located one after another in a measurement direction.

9. A method for producing a material measure of a position measurement system, comprising the steps of providing incremental and absolute markings in the material measure, which markings are scannable by a scanner movable relative to the markings; forming the incremental markings by periodically located recesses on the material measure; and locating the absolute markings between the recesses of the material measure.

10. A method as defined in claim 9; and further comprising scanning the incremental markings during a production of the absolute markings.

11. A method as defined in claim 9; and further comprising scanning the absolute markings during a production of the incremental markings.
